(19) United States
(12) Patent Application Publication
(10) Pub. No.: US 2025/0306858 A1
(43) Pub. Date: Oct. 2, 2025

(54) MATRIX TRANSPOSE UNIT OF A SEMICONDUCTOR DEVICE AND METHODS OF MANUFACTURE THEREOF

(71) Applicant: Advanced Micro Devices, Inc., Santa Clara, CA (US)

(72) Inventor: Gabriel H. Loh, Bellevue, WA (US)

(73) Assignee: Advanced Micro Devices, Inc., Santa Clara, CA (US)

(21) Appl. No.: 18/622,757

(22) Filed: Mar. 29, 2024

(51) Int. Cl. G06F 7/78; G06F 17/16

(52) U.S. Cl. CPC G06F 7/78; G06F 17/16

(57) ABSTRACT

Various devices, methods and systems are also disclosed, including an input register, output register and multiplexers. The input register includes input matrix index positions, where the input matrix index positions are configured to receive matrix values of an input matrix. The output register include output matrix index positions, where the output matrix index positions are configured to receive matrix values of an output matrix. The multiplexers include inputs wired to corresponding input matrix index positions, first outputs wired to an original matrix index positions of the output matrix index positions of the output register so as to pass the matrix values of the input matrix index positions to the output matrix index positions without transposition, and second outputs wired to transposed matrix index positions of the output matrix index positions of the output register so as to transpose the input matrix.

### BACKGROUND

Semiconductor devices and/or systems often have functional units formed from logic gates, the functional units being designed to perform particular functions, such as an adder, subtractor, divider, multiplier, comparer, input unit, output unit, memory unit, control unit, fetch unit, decode unit, encode unit, among others. Functional units related to graphics and machine learning have taken on greater prominence due to the rise of machine learning software paradigms. As a result, functional units related to the underlying matrix manipulation useful for accelerating ML workloads has become a larger part of semiconductor design.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for a matrix transpose circuit of a semiconductor device.

FIG. 2 is a block diagram of an additional example device for a matrix transpose circuit of a semiconductor device.

FIG. 3 is a block diagram of an additional example device for a matrix transpose circuit of a semiconductor device.

FIG. 4 is a flow diagram of an example method for manufacture of a matrix transpose circuit of a semiconductor device.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to matrix transpose circuitry for semiconductor devices. As will be described in more detail below, systems, devices and/or methods include circuitry configured to perform matrix transpose operations with a minimum of operations by reducing the number of registers, instructions and data movements needed to perform the transposition.

Typically, transposition of a matrix requires a processor to access sections of the matrix, reorganize the sections and remap the indices, cache the results, and reperform the process for a next portion of the matrix, until the entire matrix has been processed. The processor then re-assembles a transposed matrix from the results of the process. As a result, transposing a matrix typically requires many instructions. This is because the remapping of indices and resulting movement of values does not follow a regular pattern that maps to typical single instruction, multiple data (SIMD) and/or vector operations.

By designing hardware circuitry that hardwires input and output positions, matrix transposition may be performed with reduced instructions/operations as compared to conventional approaches, and in some embodiments with only a single instruction/operation. Thus, the matrix transpose hardware unit can be designed to efficiently transpose matrices via circuit-level wiring. Indeed, the matrix transpose hardware unit, e.g., on a semiconductor device, can include an input register including input matrix index positions mapped to indices of an input matrix. The input matrix index positions can be configured to receive matrix values of the corresponding input matrix indices of the input matrix. The matrix transpose hardware circuit can include an output register including output matrix index positions mapped to output indices of an output matrix. The output matrix index positions can be configured to receive matrix values of the corresponding output matrix indices of the output matrix. Each multiplexer can include two inputs wired to first and second input matrix positions of the input matrix index positions, and an output wired to an output matrix index position of the output matrix index positions of the output register. The first input matrix index position matches an input matrix index position of the input matrix index positions so as to pass the input matrix position without transposition (e.g., a non-transposition matrix index position), and the second input matrix index position matches a matrix index position so as to pass the second input to for transposition to the output matrix position. The matrix transpose hardware circuit can include a control unit that is configured to control the multiplexers to select between the first input and the second input of each multiplexor.

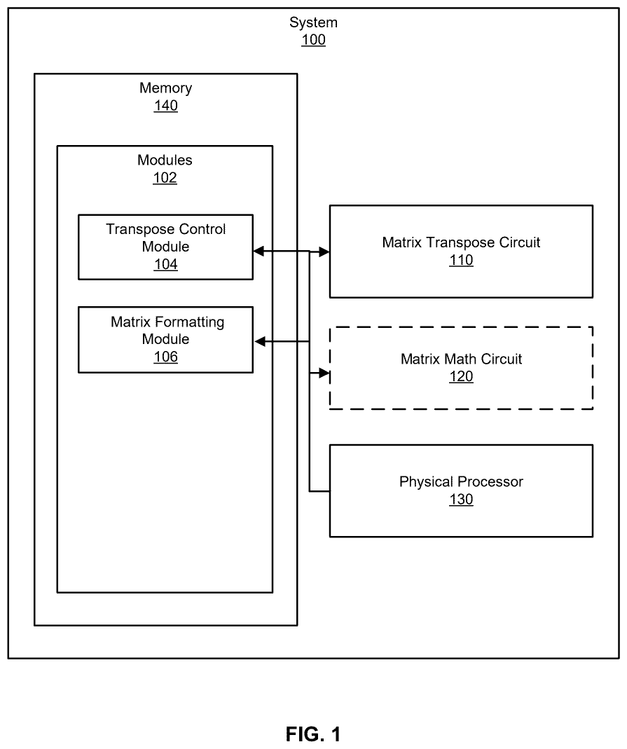

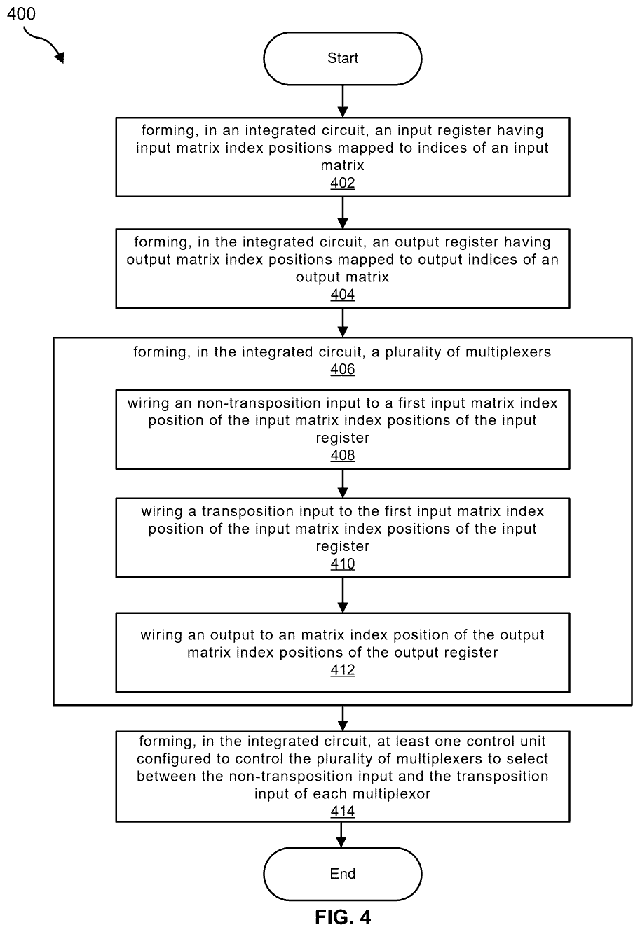

The following will provide, with reference to FIGS. 1-3, detailed descriptions of example systems for a matrix transpose circuit of a semiconductor device. Detailed descriptions of corresponding methods of manufacture will also be provided in connection with FIG. 4.

In some aspects, the techniques described herein relate to a device including: an input including input matrix index positions mapped to indices of an input matrix, wherein the input matrix index positions are configured to receive matrix values of corresponding input matrix indices of the input matrix; an output including output matrix index positions mapped to output indices of an output matrix, wherein the output matrix index positions are configured to receive matrix values of the corresponding output matrix indices of the output matrix; wherein each input matrix index position of the input matrix index positions is wired to an output matrix index position of the output matrix index positions, the output matrix index position matching a transposed position of the input matrix index position so as to pass the matrix values of the input matrix index positions to the output matrix index positions so as to transpose the input matrix.

In some aspects, the techniques described herein relate to a device, wherein diagonal input matrix indices of the input matrix indices are wired to diagonal output matrix indices of the output matrix so as to map the diagonal input matrix indices to the diagonal output matrix indices for the output.

In some aspects, the techniques described herein relate to a device, wherein the device is configured to determine that the input matrix includes more columns than rows; and wherein the input is configured to pad the input matrix with additional rows of zero values so as to produce a square matrix.

In some aspects, the techniques described herein relate to a device, further including a plurality of multiplexers, wherein each multiplexer includes: first input wiring that wires each multiplexer to a first input matrix index position of the input matrix index positions of the input, second input wiring that wires each multiplexer to a second input matrix index position of the input matrix index positions of the input, and output wiring that wires each multiplexer to the output matrix position; wherein the output matrix index position corresponds to a non-transposed position of the first input matrix index position such that selection by each multiplexer of the first input wiring passes the input matrix to the output so as to not transpose the input matrix; and wherein the output matrix index position corresponds to a transposed position of the second input matrix index position such that selection by each multiplexer of the second input wiring passes the input matrix to the output so as to transpose the input matrix.

In some aspects, the techniques described herein relate to a device, further including at least one control circuit configured to control the plurality of multiplexers to select between the first output and the second output of each multiplexor.

In some aspects, the techniques described herein relate to a device, wherein the input includes the input matrix index positions corresponding to a set of exponent positions and a set of input mantissa positions associated with block floating point data; wherein the plurality of multiplexers are wired to the set of input mantissa positions to transpose the input values corresponding to the set of input mantissa positions; wherein the output includes the output matrix index positions corresponding to the set of exponent positions and a set of output mantissa positions associated with block floating point data; and wherein the set of exponent positions of the input are wired to the set of exponent positions of the output so as to propagate the set of exponent positions from input to output.

In some aspects, the techniques described herein relate to a device, further including: a matrix math circuit in communication with the output, the matrix math circuit including circuitry configured to perform at least one mathematical operation on the output matrix; wherein the matrix math circuit includes a matrix multiplier circuit configured to: receive a second matrix, and perform the at least one mathematical operation on the output matrix by multiplying the output matrix and the second matrix.

In some aspects, the techniques described herein relate to a system including: at least one integrated circuit having a plurality of functional circuits; and wherein the plurality of functional circuits includes a matrix transposition function circuit including: an input including input matrix index positions mapped to indices of an input matrix, wherein the input matrix index positions are configured to receive matrix values of corresponding input matrix indices of the input matrix; an output including output matrix index positions mapped to output indices of an output matrix, wherein the output matrix index positions are configured to receive matrix values of the corresponding output matrix indices of the output matrix; wherein each input matrix index position of the input matrix index positions is wired to an output matrix index position of the output matrix index positions, the output matrix index position matching a transposed position of the input matrix index position so as to pass the matrix values of the input matrix index positions to the output matrix index positions so as to transpose the input matrix.

In some aspects, the techniques described herein relate to a system, wherein diagonal input matrix indices of the input matrix indices, the diagonal input matrix indices corresponding to a diagonal of the input matrix.

In some aspects, the techniques described herein relate to a system, wherein the matrix transposition function circuit is configured to determine that the input matrix includes more columns than rows; and wherein the input is configured to pad the input matrix with additional rows of zero values so as to produce a square matrix.

In some aspects, the techniques described herein relate to a system, wherein the matrix transposition function circuit further includes a plurality of multiplexers, wherein each multiplexer includes: first input wiring that wires each multiplexer to a first input matrix index position of the input matrix index positions of the input, second input wiring that wires each multiplexer to a second input matrix index position of the input matrix index positions of the input, and output wiring that wires each multiplexer to the output matrix position; wherein the output matrix index position corresponds to a non-transposed position of the first input matrix index position such that selection by each multiplexer of the first input wiring passes the input matrix to the output so as to not transpose the input matrix; and wherein the output matrix index position corresponds to a transposed position of the second input matrix index position such that selection by each multiplexer of the second input wiring passes the input matrix to the output so as to transpose the input matrix.

In some aspects, the techniques described herein relate to a system, further including at least one control circuit configured to control the plurality of multiplexers to select between the first output and the second output of each multiplexor.

In some aspects, the techniques described herein relate to a system, wherein the input includes the input matrix index positions corresponding to a set of exponent positions and a set of input mantissa positions associated with block floating point data; wherein the plurality of multiplexers are wired to the set of input mantissa positions to transpose the input values corresponding to the set of input mantissa positions; wherein the output includes the output matrix index positions corresponding to the set of exponent positions and a set of output mantissa positions associated with block floating point data; and wherein the set of exponent positions of the input are wired to the set of exponent positions of the output so as to propagate the set of exponent positions from input to output.

In some aspects, the techniques described herein relate to a system, further including: a matrix math circuit in communication with the output, the matrix math circuit including circuitry configured to perform at least one mathematical operation on the output matrix; wherein the matrix math circuit includes a matrix multiplier circuit configured to: receive a second matrix, and perform the at least one mathematical operation on the output matrix by multiplying the output matrix and the second matrix.

In some aspects, the techniques described herein relate to a method of manufacturing a semiconductor device including: forming an input including input matrix index positions mapped to indices of an input matrix, wherein the input matrix index positions are configured to receive matrix values of corresponding input matrix indices of the input matrix; forming an output including output matrix index positions mapped to output indices of an output matrix, wherein the output matrix index positions are configured to receive matrix values of the corresponding output matrix indices of the output matrix; wherein each input matrix index position of the input matrix index positions is wired to an output matrix index position of the output matrix index positions, the output matrix index position matching a transposed position of the input matrix index position so as to pass the matrix values of the input matrix index positions to the output matrix index positions so as to transpose the input matrix.

In some aspects, the techniques described herein relate to a method, wherein diagonal input matrix indices of the input matrix indices, the diagonal input matrix indices corresponding to a diagonal of the input matrix.

In some aspects, the techniques described herein relate to a method, further including forming a plurality of multiplexers, wherein forming each multiplexer includes: forming first input wiring that wires each multiplexer to a first input matrix index position of the input matrix index positions of the input, forming second input wiring that wires each multiplexer to a second input matrix index position of the input matrix index positions of the input, and forming output wiring that wires each multiplexer to the output matrix position; wherein the output matrix index position corresponds to a non-transposed position of the first input matrix index position such that selection by each multiplexer of the first input wiring passes the input matrix to the output so as to not transpose the input matrix; and wherein the output matrix index position corresponds to a transposed position of the second input matrix index position such that selection by each multiplexer of the second input wiring passes the input matrix to the output so as to transpose the input matrix.

In some aspects, the techniques described herein relate to a method, further including forming at least one control circuit configured to control the plurality of multiplexers to select between the first output and the second output of each multiplexor.

In some aspects, the techniques described herein relate to a method, further including: forming the input to include the input matrix index positions corresponding to a set of exponent positions and a set of input mantissa positions associated with block floating point data; wiring the plurality of multiplexers to the set of input mantissa positions to transpose the input values corresponding to the set of input mantissa positions; wherein the output includes the output matrix index positions corresponding to the set of exponent positions and a set of output mantissa positions associated with block floating point data; and wiring the set of exponent positions of the input to the set of exponent positions of the output so as to propagate the set of exponent positions from input to output.

In some aspects, the techniques described herein relate to a method, further including: forming, in the semiconductor device, a matrix math circuit in communication with the output, the matrix math circuit including circuitry configured to perform at least one mathematical operation on the output matrix; wherein the matrix math circuit includes a matrix multiplier circuit configured to: receive a second matrix, and perform the at least one mathematical operation on the output matrix by multiplying the output matrix and the second matrix.

FIG. 1 is a block diagram of an example system 100 for a matrix transpose hardware circuit of a semiconductor device. As illustrated in this figure, example system 100 can include one or more modules 102 for performing one or more tasks. As will be explained in greater detail below, modules 102 can include a transpose control module 104 and a matrix formatting module 106. Although illustrated as separate elements, one or more of modules 102 in FIG. 1 can represent portions of a single module or application.

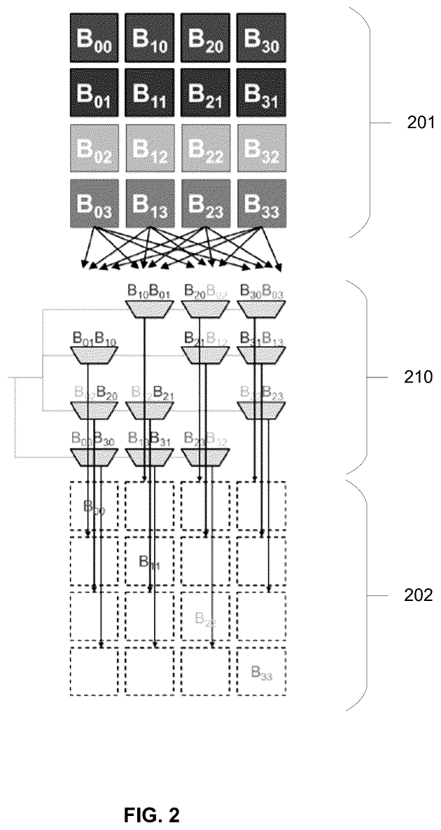

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices using a matrix transpose circuit 110, such as the devices illustrated in FIGS. 2 and/or 3. One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate efficient matrix transposition via a matrix transpose circuit 110. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more additional processing circuits including the matrix transpose circuit 110 and/or a matrix math circuit 120. Matrix transpose circuit 110 and/or matrix math circuit 120 generally represent any type or form of semiconductor device circuitry. As such, matrix transpose circuit 110 and/or matrix math circuit 120 can be operably connected to physical processor 130 to provide hardware-based matrix transposition operations and/or hardware-based matrix math operations to physical processor 130. Accordingly, matrix transpose circuit 110 and/or matrix math circuit 120 can be integrated into physical processor 130 as functional processing units of physical processor 130, where the term “functional unit” or “functional processing unit” as used herein refers to a part of a semiconductor device that performs one or more of the operations and calculations called for by the computer program, and can have its own internal control sequence unit (as opposed to physical processor 130 main control unit), registers, and other internal units such as a sub-ALU or FPU, or some smaller, more specific components.

Matrix transpose circuit 110 can include circuitry for ingesting a matrix from an input register and output a transposed matrix by repositioning the data of each position in the input register to a transposed position in an output register. Because matrix transposition does not follow a pattern that can be efficiently addressed using instructions and/or circuits of typical processors, software-based matrix transposition can require numerous operations and memory accesses to reorganize the data into a new transposed matrix in memory. But, in matrix transposition, the indices of the matrix are flipped about the diagonal of the matrix. Thus, the transposed index for a particular value of the matrix in an original index is predictable. Accordingly, the original positions can be hardwired to the transposed positions as those relationship remain constant for a given matrix size. By hardwiring register positions between input and output registers, matrix transpose circuit 110 can reduce the number of operations needed to transpose a matrix.

In some embodiments, the matrix transpose circuit 110 can be configured for a matrix of any of one or more sizes, such as a matrix having 2 or more rows and 2 or more columns, and may be square or rectangular. Accordingly, the size of the input and output registers can be configured for different numbers of bits depending on the size of the matrix and the matrix data format. In some examples, the input register and/or the output register can be structured as one-dimensional arrays. Thus, matrix formatting module 106 format the matrix to conform to the one-dimensional array format of the register (e.g., concatenating each row of the matrix into a single row) if it is not already. In some examples, the input register and/or the output register can be structured as a two-dimensional array. Accordingly, the matrix formatting module 106 can format the matrix in a two dimensional array format if it is not already. Thus, the matrix formatting module 106 can identify the format of the input register and/or output register, and the format of the matrix as stored in memory 140 or as specified by an instruction, and reformat the matrix to conform to the format of the input register and/or output register. In some examples, the format can include dimensionality, number of bits per value, data type (e.g., floating point, blocked floating point, integer, etc.), among others or any combination thereof. Similarly, upon output of the transposed matrix to the output register, matrix formatting module 106 may return the transposed matrix from the format of the output register to the format in which the transposed matrix is to be stored, e.g., the format of the original un-transposed matrix.

In some examples, matrix formatting model 106 may also adjust the matrix based on the size of the input register. For example, the input register may have positions for a particular sized matrix, while the matrix may be of a smaller size. To accommodate the size difference, matrix formatting module 106 can determine the size difference between the input register and the matrix, including a difference is a number of rows and/or a difference in a number of columns. Based on the size difference, matrix formatting model 106 can pad the rows and/or columns of the matrix to fill out the positions in the input register, e.g., by inserting nonces, zeros or other data into the matrix to fill the rows and/or columns of the input register. Similarly, the matrix formatting module 106 pad rows and/or columns of the matrix to make a square matrix when the matrix is non-square.

Matrix formatting module 106 can track the indices and/or positions of the matrix that have been padded. Thus, upon transposition and output to the output register of the transposed matrix, matrix formatting module 106 can remove the padded rows and/or columns. Alternatively, or in addition, the data used to pad the matrix can include data that can automatically be recognized as a padding value rather than a value of the matrix (“matrix value”). Accordingly, matrix formatting module 106 can detect the padding value(s) of the transposed matrix at the output register to remove the padding.

While the input and output of the matrix transpose circuit 110 are described throughout the present disclosure as being an input register and an output register, respectively, in one or more examples, the input and/or the output may instead by another functional processing unit, semiconductor device, memory, or other component and/or circuitry. For example, the output may be directly wired to the matrix math circuit 120, the physical processor 130, the memory 140, or other circuitry or any combination thereof. Similarly, the input may be directly wired to the matrix math circuit 120, the physical processor 130, the memory 140, or other circuitry or any combination thereof.

In one or more examples, transposition may be controllably selected for any particular matrix. To do so, the input register positions may be wired, via multiplexers, to output register positions such that control of the multiplexers can select between moving an input index position to a corresponding output index position to not transpose the matrix, or moving a different index position to the output index position so as to move the different index position to a transposed position. Thus the multiplexers may select between outputting data from a to-be transposed input register position or form a not-to-be transposed input register position based on a control signal from transpose control module 104.

In one or more examples, the transposed or un-transposed matrix can be output by the output register to store the transposed or un-transposed matrix in memory 140. Alternatively, or in addition, the transposed or un-transposed matrix can be accessed or otherwise obtained from the output register by matrix math circuit 120 to perform one or more operations with the transposed or un-transposed matrix, such as matrix multiplication, addition, dot product, convolution, or other matrix operation or any combination thereof. As detailed above, the output of the matrix transpose circuit 120 may be wired directly to the matrix math circuit 120 so as to reduce circuitry by bypassing an output register.

In some examples, matrix math circuit 120 can perform mathematical operations using the transposed or un-transposed matrix in the output of the matrix transpose circuit 120 as well as one or more additional matrices. The one or more additional matrices can include matrices accessed in memory 140, and/or one or more additional registers, and/or one or more additional transposed or un-transposed matrices accessed or otherwise obtained from at least one additional matrix transpose circuit 110.

In one or more examples, matrix transpose circuit 110, matrix math circuit 120 and/or the at least one additional matrix transpose circuit 110 may be implemented as separate circuitry forming separate functional units of the system 100. Alternatively, matrix transpose circuit 110, matrix math circuit 120 and/or the at least one additional matrix transpose circuit 110 may be implemented as an integrated functional block whereby the circuitry of each circuit is integrated together.

Accordingly, in one or more examples, a software program (e.g., embodied as one or more additional modules of modules 102) can include instructions for performing matrix operations. Physical processor 130 can be configured to interpret the instructions and implement matrix transpose circuit 110 and matrix math circuit 120. As such, the matrices of the matrix operations can be provided to matrix transpose circuit 110. Based on whether the matrix operations include a transposition of one or more of the matrices, transpose control module 104 can provide a signal to the multiplexers of the matrix transpose circuit 110 of each matrix to selected between the transposition or non-transposition input register positions of the input register.

For example, a first matrix may be provided to a first matrix transpose circuit 110 and a second matrix may be provided to a second matrix transpose circuit 110. The operation may be matrix multiplication. Thus, the first matrix can be determined to be un-transposed for the matrix multiplication operation, while the second matrix can be determined to be transposed. Thus, matrix control module 104 can send a control signal to the first matrix transpose circuit 110 to select the input register positions associated with an un-transposed matrix. Matrix control module 104 can send another control signal to the second matrix transpose circuit 110 to control the multiplexers thereof to select the input register positions associated with a transposed matrix. As a result, the first matrix can pass through the first matrix transpose circuit 110 un-transposed while the second matrix can be transposed by the second matrix transpose circuit 110. Both matrices can then be accessed by matrix math circuit 120 to perform the matrix multiplication task.

In some examples, where the matrix transpose circuit 110 and matrix math circuit 120 are integrated into a single functional unit, the transposition operation and matrix math operation can be performed without additional instructions and/or memory calls by outputting each matrix directly from the outputs to matrix math circuit 120. Thus, the outputs of matrix transpose circuit(s) 110 can also serve as inputs to matrix math circuit 120. Alternatively, the output registers can first communicate the matrices to input registers of matrix math circuit 120. In some embodiments, the output of one or more of the matrix transpose circuits 110 and/or the input of the matrix math circuit 120 may include one or more registers, or may be hardwired directly to the associated processing circuitry, or any combination thereof. In one or more examples, the input(s) and/or output(s) of matrix transpose circuits 110 and/or the input of matrix math circuit 120 may be separated by memory 140 or other data store, cache or buffer.

Accordingly, the software program and physical processor 130 can leverage matrix transpose circuit 110 and matrix math circuit 120 to quickly and efficiently perform matrix operations using reduced operations and memory access operations than typical approaches.

Example system 100 in FIG. 1 can be implemented in a variety of ways. For example, all or a portion of example system 100 can represent portions of a computing device in communication with a server via a network. In one example, all or a portion of the functionality of modules 102 can be performed by computing device, server, and/or any other suitable computing system. As will be described in greater detail below, one or more of matrix transpose circuit 110 and/or matrix math circuit 120 from FIG. 1 can, be provided on one or both of computing device and/or server for hardware circuitry for matrix transposition and matrix math operations.

Computing device generally represents any type or form of computing device capable of reading computer-executable instructions. Additional examples of computing device include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Examples of server include, without limitation, storage servers, database servers, application servers, and/or web servers configured to run certain software applications and/or provide various storage, database, and/or web services. Server can include and/or represent a plurality of servers that work and/or operate in conjunction with one another.

Network generally represents any medium or architecture capable of facilitating communication or data transfer. In one example, network can facilitate communication between computing device and server. In this example, network can facilitate communication or data transfer using wireless and/or wired connections. Examples of network include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1. Conversely, all of the components and devices illustrated in FIG. 1 need not be present to practice the implementations described and/or illustrated herein. The devices and subsystems referenced above can also be interconnected in different ways from that shown in FIG. 1. System 100 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 2 is a block diagram of an additional example device for a matrix transpose circuit of a semiconductor device.

Matrix multiplication may enable machine learning (ML), high performance compute (HPC), and many other important workloads. In many situations, one of the matrices needs to be transposed before the matrix multiplication, which typically requires many additional instructions, registers, and data movements costing power and performance. As detailed above, embodiments of the present disclosure provide a combination of a hardware-based matrix transpose circuit 110 and a hardware-based matrix math circuit 120, which may operate as an integrated functional unit or as separate functional units of a semiconductor device, thereby increasing the performance and reducing the power for these common operations.

Matrix multiply with transposition of one of the arguments is common in many matrix-oriented workloads (e.g., ML), usually of the form C=A*B^{T} where A is a first matrix, B^{T} is a transpose of a second matrix B, and C is a resulting matrix. While the movement of elements within the matrix are statically determined, the movements do not follow a pattern that easily maps to typical SIMD/vector operations available in typical graphical processing units (GPUs), central processing units (CPUs) with vector extensions (e.g., AVX512), etc.

To solve this problem, an example leverages a property of a matrix transpose operation, the property being that the matrix transpose operation only rearranges where data are located. As such, the example provides hardware-based circuitry that uses interconnection circuitry, such as wires, arranged to route data elements to supply transposed matrix values their target positions to yield the transposed matrix in order to create computationally lightweight transpose operations. In the example, matrix transpose circuit 110 is a first sub-unit that performs an optional transpose operation based on a control input. For example, if the control input provided by transpose control module 104 signals “no transpose”, then the optional transpose block simply passes matrix input B unmodified to the matrix math circuit 120 sub-unit via an output register 202. In another example, if the control input provided by transpose control module 104 signals “transpose”, then the optional transpose block transposes matrix input B to pass transposed matrix B^{T} to the matrix math circuit 120 sub-unit. In the example, the output (possibly transposed based on the control input) is multiplied with matrix input A, which may or may not be operated on by another matrix transpose circuit 110, producing the final output. The second matrix-multiply unit can be implemented as any standard matrix-multiply circuit such as those implementing arrays of multiply-accumulate (MAC) operations/circuits.

FIG. 2, as detailed above, provides details of an example implementation of the Optional Transpose sub-unit for 4×4 matrices. Depending on the control input (“is_transpose_op”), individual multiplexors 210 can select either the element from the current position in the input register 201 or the element from the transposed position. For example in FIG. 2, the first multiplexor 210 from the left in the top of row chooses between elements B10 (the element corresponding to no transpose) and element B01 (the element corresponding to the transpose of B at this matrix location). According to one or more aspects, no multiplexors 210 may be provided in the positions along the main diagonal because the value is identical regardless of whether the matrix is transposed or not, and so the corresponding value is simply passed through (e.g., at position 0,0 of the matrix, the value of element B00 becomes the output value of the matrix transpose circuit 110 sub-unit for this position of the matrix, represented by the red B00 in the “dotted line” matrix entries that represent the matrix output in the output register 202 of the matrix transpose circuit 110 sub-unit.

According to one or more aspects, physical processor 130 may define a new instruction to invoke the matrix-matrix-transpose multiplication operation. For example, a “MatMul” instruction encodes a traditional (non-transposed) matrix multiply operation, which passes input matrix arguments A and B to the matrix transpose circuit 110 and matrix math circuit 120 while setting the matrix transpose circuit 110 is_transpose_op to zero (to indicate that matrix B should not be transposed). The matrix math circuit 120 can then perform the matrix multiplication on A and B to generate the desire output. In another example, a “MatMulT” instruction (e.g., matrix multiplication with transpose), which encodes a transposed matrix multiplication operation, that operates similar to MatMul but instead sets the matrix transpose circuit 110 is_transpose_op input to one (1) indicating that the matrix input B is to be transposed prior to the matrix multiply operation.

In one or more examples, the is_transpose_op may be provided directly by an input register 201 (e.g., MatMutT C, A, B, T), where the optional transpose operation is performed based on whether the input register 201 T contains a zero or one (or zero vs. non-zero, or other binary selector).

In one or more examples, a second matrix transpose circuit 110 could be applied to matrix input A instead of, or in addition to, the unit that operates on matrix input B, thus enabling additional operations such as A^{T}*B or A^{T}*B^{T}.

In some embodiments, matrix transpose circuit 110 and matrix math circuit 120 can be implemented on an instruction-driven (programmable) processor, such as a CPU, GPU, or DSP. In one or more additional examples, matrix transpose circuit 110 and matrix math circuit 120 can be implemented on dedicated AI accelerators, tensor/neural processor units, neuromorphic accelerators, or programmable logic (e.g., FPGAs), or any combination thereof by omitting explicit instruction-level support for the transpose operation, and as a result the is_transpose_op signal may be provided from a different source such as a programmable bitstream, a flop-flop or latch, a memory location, among others or any combination thereof.

In some examples, the matrix transpose circuit 110 and/or matrix math circuit 120 can be applied to any numerical formats that a normal (non-transposing) matrix-multiply unit could use (e.g., FP16, FP8, INT8, blocked floating point formats, etc.).

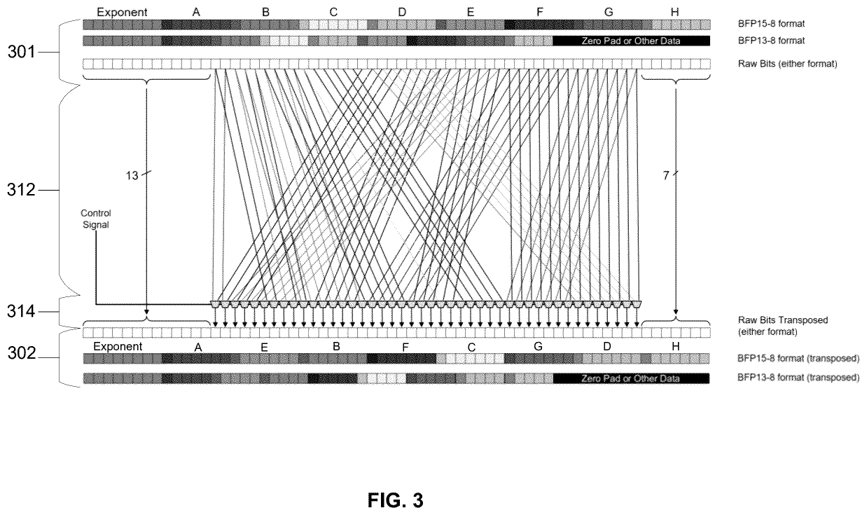

FIG. 3 is a block diagram of an additional example device for a matrix transpose circuit of a semiconductor device.

In one or more illustrative examples, matrix transposition circuitry of a semiconductor device, including methods of use and manufacture thereof, to perform matrix transposition of matrices in Blocked Floating Point (BFP) number formats. BFP number formats provide an increase in data packing efficiency that can improve the memory and computational performance of processors, especially in AI and ML workloads. However, use of BFP has technical drawbacks because matrix transpose operations can be costly, requiring multiple separate instructions to piece together the transposed output with repacking in the BFP format with possible impacts on numerical accuracy. Accordingly, at least one illustrative example includes matrix transpose circuit 110 and corresponding processor instructions to directly perform transpose operations of BFP number formats (including related formats like micro-exponents, e.g., MX4, MX6) to reduce the performance costs that could otherwise be incurred with using BFP formats.

The illustrative example includes new instructions and corresponding circuits to enable and/or accelerate the transpose operation when operating on BFP data (including MX4, MX8). The illustrative example can utilize permutation/shuffle networks to support permute and value intersect instructions, but with non-byte-aligned data boundaries corresponding to the BFP format, and without requiring full any-to-any data steering (as required in current permute circuits), and can also support renormalization of values based on a new shared exponent of the remapped (transposed) data.

In an illustration of the example, eight data values can be packed into a BFP15-8 format, where 15 represents the effective/equivalent bit width if represented as a traditional floating point value, and 8 is the size/width of the shared exponent, though other block floating point formats may be employed such as BFP16-8 and BFP13-8. In this illustration, even though a single value appears to use 16 bits (1 sign, 8 exponent, 7 mantissa), in a conventional floating point value the first bit of the mantissa can be automatically implied whereas in BFP format the leading one is explicitly encoded. In this illustration, eight separate values (with a shared exponent) are encoded in a total of 64 bits, with an effective cost of 8 bits per value despite the 15-bit equivalent format.

In illustrative examples, matrix transpose circuit 110 can include an input register 301 having an exponent portion followed by one or more positions for bits corresponding to the value in that position (e.g., the mantissa) such as A, B, C, D, E, F, G, and H as illustrated in FIG. 3. Similarly, matrix transpose circuit 110 can include an output register 302 having an exponent portion followed by one or more positions for bits corresponding to the value corresponding to an optionally transposed position relative to the input register 301 (e.g., the mantissa). Connecting the input register 301 to the output register 302 is wiring 312 and multiplexers 314, signified by the lines mapping input register 301 bits to output register 302 bits. As detailed above, the multiplexers 314 can be controlled to select a first output register position associated with a non-transposed position, and a second output register position corresponding to a transposed position, thus enabling optional transposition of BFP matrices.

The BFP format does not automatically imply any specific spatial/structural relationship among its values. For example, the 8 BFP values detailed above could be interpreted by application software as 8 consecutive values in a one-dimensional vector, as two rows of four elements (e.g., a 4×2 matrix), as four rows of two elements (e.g., a 2×4 matrix), or as a column of eight values. As illustrated in FIG. 3, where the eight positions, A, B, C, D, E, F, G, and H, related to a 2×4 matrix, the positions may be mapped to output positions corresponding to a 4×2 transposed matrix, e.g., A, E, B, F, C, G, D, H. This mapping is illustrative and non-limiting. Indeed, matrices of other sizes may having different mappings for transposition, such as matrix transposition of input matrices having sizes including, but not limited to: 2×2, 2×3, 2×4, 2×5, 2×6, 2×7, 2×8, 2×9, 2×10, 2×11, 2×12, 2×13, 2×14, 2×15, 2×16, 3×2, 3×3, 3×4, 3×5, 3×6, 3×7, 3×8, 3×9, 3×10, 3×11, 3×12, 3×13, 3×14, 3×15, 3×16, 4×2, 4×3, 4×4, 4×5, 4×6, 4×7, 4×8, 4×9, 4×10, 4×11, 4×12, 4×13, 4×14, 4×15, 4×16, 5×2, 5×3, 5×4, 5×5, 5×6, 5×7, 5×8, 5×9, 5×10, 5×11, 5×12, 5×13, 5×14, 5×15, 5×16, 6×2, 6×3, 6×4, 6×5, 6×6, 6×7, 6×8, 6×9, 6×10, 6×11, 6×12, 6×13, 6×14, 6×15, 6×16, 7×2, 7×3, 7×4, 7×5, 7×6, 7×7, 7×8, 7×9, 7×10, 7×11, 7×12, 7×13, 7×14, 7×15, 7×16, 8×2, 8×3, 8×4, 8×5, 8×6, 8×7, 8×8, 8×9, 8×10, 8×11, 8×12, 8×13, 8×14, 8×15, 8×16, 9×2, 9×3, 9×4, 9×5, 9×6, 9×7, 9×8, 9×9, 9×10, 9×11, 9×12, 9×13, 9×14, 9×15, 9×16, 10×2, 10×3, 10×4, 10×5, 10×6, 10×7, 10×8, 10×9, 10×10, 10×11, 10×12, 10×13, 10×14, 10×15, 10×16, 11×2, 11×3, 11×4, 11×5, 11×6, 11×7, 11×8, 11×9, 11×10, 11×11, 11×12, 11×13, 11×14, 11×15, 11×16, 12×2, 12×3, 12×4, 12×5, 12×6, 12×7, 12×8, 12×9, 12×10, 12×11, 12×12, 12×13, 12×14, 12×15, 12×16, 13×2, 13×3, 13×4, 13×5, 13×6, 13×7, 13×8, 13×9, 13×10, 13×11, 13×12, 13×13, 13×14, 13×15, 13×16, 14×2, 14×3, 14×4, 14×5, 14×6, 14×7, 14×8, 14×9, 14×10, 14×11, 14×12, 14×13, 14×14, 14×15, 14×16, 15×2, 15×3, 15×4, 15×5, 15×6, 15×7, 15×8, 15×9, 15×10, 15×11, 15×12, 15×13, 15×14, 15×15, 15×16, 16×2, 16×3, 16×4, 16×5, 16×6, 16×7, 16×8, 16×9, 16×10, 16×11, 16×12, 16×13, 16×14, 16×15, 16×16, or any other matrix size based on the format and/or any other factors.

As further illustration of the example, let us assume that a software program can utilize the BFP values as a matrix of two rows of four values each (e.g., a 4×2 matrix). To perform a transpose operation, individual values have their positions swapped so that, in this illustration, the resulting matrix is in a 2×4 organization with values “reflected” along the diagonal of the matrix. When packed linearly into the original BFP format, individual elements/values are repositioned to different positions.

FIG. 3 shows an exemplary matrix transpose circuit 110 for performing a 4×2 to 2×4 matrix transpose of BFP values. Because the individual values are not being modified (not increased nor decreased), the shared exponent does not need to be changed. As a result, matrix transpose circuit 110 can propagate the shared exponent, and then rearrange the positions of some of the values (the circuit in this implementation includes wires routing specific sets of bits to new locations corresponding to a transposition. Note that existing AVX512 permute instructions (and corresponding circuits) cannot perform this operation because the existing AVX512 circuits operate only on byte boundaries, whereas the BFP transpose operation requires moving chunks of data (a continuous subset of bits) that in general need to cross the byte boundaries. Along with matrix transpose circuit 110, physical processor 130 can support one or more instructions (e.g., “bfptranspose”) that direct the physical processor 130 to perform the transpose operation utilizing matrix transpose circuit 110.

In a one or more other forms of the illustrative example of matrix transpose circuit 110, matrix transpose circuit 110 can support micro-exponent formats (e.g., MX4, MX6, MX9), in addition to moving the positions of values corresponding to the transpose operations, values may be moved across partitions. Accordingly, matrix formatting module 106 can provide an additional rescaling circuit to choose an appropriate micro-exponent and rescale the values as appropriate.

The illustrative example can include a new instruction and corresponding circuit to assemble transposed sub-matrices into a larger transposed matrix. In the example, a 4×4 matrix can be stored as two BFP15-8 values (each storing eight sub-values) which is to be transposed. To do so, matrix transpose circuit 110 can first utilize the BFP transpose instruction on each half of the 4×4 matrix (each half being either the upper 4×2 or lower 4×2 sub-matrix) to transpose the sub-matrices. Matrix transpose circuit 110 can then utilize a new instruction that selects sub-portions of each sub-matrix to generate corresponding sub-matrices of the final output (e.g., the transpose of the original 4×4 matrix). Such an instruction (which can be called “bfpmatsplice” here, short for “BFP matrix splice”) can also perform an exponent renormalization operation (which may be performed by matrix transpose circuit 110, or by matrix formatting module 104, or a combination thereof) to ensure that the shared exponent from the first input is equal to the shared exponent from the second input. According to the example, the bfpmatsplice instruction is invoked twice, once with a “top” argument that outputs the top half of the final transposed 4×4 matrix, and then a second time with a “bottom” argument that outputs the bottom half of the final transposed 4×4 matrix. In one implementation, the renormalization operation takes the larger of the two exponents, and then readjusts (e.g., shifts) the individual values accordingly to represent their values given the new shared exponent. Other strategies for renormalization can be employed, for example taking the average of the shared exponents and then adjusting all sub-values accordingly, possibly saturating mantissas at the maximum representable value if the scaling adjustment would otherwise result in a numerical overflow.

As detailed above, examples can utilize a BFP15-8 data format, but the instruction and circuit can be applied/extended to other blocked floating-point formats as well (e.g., BFP16-8, BFP13-8, MX9, MX6, MX4). To support multiple formats, the BFP transpose circuit can incorporate additional multiplexing to support transpose operations for both BFP15-8 and BFP13-8 formats. BFP13-8 uses an average of 6 bits per value and so the eight packed values fit in a total of 48 bits of storage, and any remaining bits in a (for example) 64-bit register file can be zero-padded or filled with other values as detailed above. In this example, an additional control input/signal for matrix transpose circuit 110 can determine whether the circuit performs a transpose operation on data formatted as BFP15-8 or BFP13-8. Some output bits (the first 13 and the last 7) can be identical to their corresponding input bit positions regardless of whether the input register 301 is interpreted as a BFP15-8 or BFP13-8 set of values, and as such can be written directly from their respective positions from the input register to the output register. For the remaining bits, a multiplexer 314 for each output register 302 bit either selects a bit from the input register corresponding to a transpose of a BFP15-8 input or a transpose of a BFP13-8 input. According to some aspects, a format control signal, e.g., from matrix formatting module 106, can be specified as an input operand to the instruction, or different instructions can encode transposition for different formats (with each instruction causing the circuit to be operated with the control input set to a different value). While two formats are detailed for simplicity of illustration, but the illustrative examples can also cover implementations that can support more than two number of formats (at the cost of more wiring and multiplexing).

One or more other forms of the illustrative examples can operate on multiple packed BFP values at the concurrently. For example, a 2-way “vector” of BFP15-8 values that together encode 16 sub-values (A-P), can, for example, represent a 4×4 matrix, similar to the example detailed above. In the present form of the illustrative example, a single instruction can take the 128-bit input (e.g., 2 BFP15-8 values of 64 bits each) and perform the transpose and renormalizations in a single matrix transpose circuit 110, thus using fewer instructions and no temporary registers.

Extending the prior example further, a 512-bit vector register (such as those supported by the AVX512 instruction set extension of the x86 ISA) can hold eight BFP15-8 values, representing a total of 64 sub-values. Such eight BFP15-8 values can be interpreted as four 4×4 matrices, and a vector version of the transpose instruction (with the aid of four instances of a matrix transpose circuit 110 and renormalize circuit, e.g., of matrix formatting module 106) can concurrently perform four transpose operations on each of the individual 4×4 matrices. When combined with additional instructions (e.g., vector permute (VPERMB/D/Q)), the vector permute can first perform a sub-matrix transpose operation on the aggregate byte-aligned BFP chunks, and then invoke the vector version of the current illustrative example to perform element-level transposes on each of the individual 4×4 sub-matrices. Alternatively, the 512-bit register could be interpreted as a single larger 8×8 matrix with the corresponding circuit to perform a full 8×8 transpose operation (plus renormalization for the eight output BFP values) depending on circuit/wire-area budgets.

FIG. 4 is a flow diagram of an example method for manufacture of a matrix transpose circuit of a semiconductor device.

In accordance with one or more aspects, the method for manufacture of the matrix transpose circuit 110 of a semiconductor device can include, at step 402, forming, in an integrated circuit, an input register including input matrix index positions mapped to indices of an input matrix, where the input matrix index positions are configured to receive matrix values of the corresponding input matrix indices of the input matrix;

In accordance with one or more aspects, the method for manufacture of the matrix transpose circuit 110 of a semiconductor device can include, at step 404, forming, in the integrated circuit, an output register including output matrix index positions mapped to output indices of an output matrix, where the output matrix index positions are configured to receive matrix values of the corresponding output matrix indices of the output matrix;

In accordance with one or more aspects, the method for manufacture of the matrix transpose circuit 110 of a semiconductor device can include, at step 406, forming, in the integrated circuit, a plurality of multiplexers. Forming the multiplexers can include, at step 408, wiring an input to a corresponding one of the input matrix index positions. Forming the multiplexers can include, at step 410, wiring a first output to an original matrix index position of the output matrix index positions of the output register, the original matrix index position matching an input matrix index position of the input matrix index positions so as to pass the input matrix without transposition. Forming the multiplexers can include, at step 412, wiring a second output to a transposed matrix index position of the output matrix index positions of the output register, the original matrix index position matching a transposition of an input matrix index position of the input matrix index positions so as to transpose the input matrix.

In accordance with one or more aspects, the method for manufacture of the matrix transpose circuit 110 of a semiconductor device can include, at step 414, forming, in the integrated circuit, at least one control circuit configured to control the plurality of multiplexers to select between the first output and the second of each multiplexor.

As explained above with reference to FIGS. 1-4, the present disclosure details matrix transposition circuitry of a semiconductor device, including methods of use and manufacture thereof, to perform matrix multiplication.

Additionally, as explained above with reference to FIGS. 1-4, the present disclosure details matrix transposition circuitry of a semiconductor device, including methods of use and manufacture thereof, to perform matrix transposition of matrices in BFP number formats. BFP number formats provide an increase in data packing efficiency that can improve the memory and computational performance of processors, especially in AI and ML workloads. However, use of BFP has technical drawbacks because matrix transpose operations can be costly, requiring multiple separate instructions to piece together the transposed output with repacking in the BFP format with possible impacts on numerical accuracy. Accordingly, at least one illustrative example includes matrix transpose circuit 110 and corresponding processor instructions to directly perform transpose operations of BFP number formats (including related formats like micro-exponents, e.g., MX4, MX6) to reduce the performance costs that could otherwise be incurred with using BFP formats.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
an input to receive, for a plurality of input matrix index positions, matrix values of corresponding input matrix indices of an input matrix;
an output to supply, for a plurality of output matrix index positions, matrix values of corresponding output matrix indices of an output matrix; and
interconnection circuitry to connect each input matrix index position of the plurality of input matrix index positions of the input to an output matrix index position of the plurality of output matrix index positions of the output, each output matrix index position matching a transposed position of a corresponding input matrix index position and the interconnection circuitry being arranged so as to pass matrix values for the input matrix index positions to a corresponding output matrix index positions to yield the output matrix that is a transposition of the input matrix.

2. The device of claim 1, wherein the interconnection circuitry directly connects each input matrix index position, of the plurality of input matrix index positions, corresponding to diagonal input matrix indices of the input matrix to an output matrix index position, of the plurality of output matrix index positions, for a corresponding diagonal output matrix index of the output matrix.

3. The device of claim 1, wherein the device is configured to pad the input matrix with additional rows of zero values to produce a square matrix when the input matrix comprises more columns than rows.

4. The device of claim 1, wherein the interconnection circuitry comprises a plurality of multiplexers, wherein each multiplexer comprises:
first input wiring that wires each multiplexer to a first input matrix index position of the input matrix index positions of the input,
second input wiring that wires each multiplexer to a second input matrix index position of the input matrix index positions of the input, and
output wiring that wires each multiplexer to the output matrix index positions of the output;
wherein each multiplexer is configured to select between the first input matrix index position and the second input matrix index position;
wherein the first input matrix position and the output matrix index position are a same matrix index position of the input matrix such that selection of the first input matrix position produces the output matrix as the same as the input matrix; and
wherein the second input matrix position and the output matrix index position are different matrix index positions such that selection of the second input matrix position produces the output matrix as the transposition of the input matrix.

5. The device of claim 4, further comprising at least one control circuit configured to control the plurality of multiplexers to select between the first input matrix index position and the second input matrix index position.

6. The device of claim 4, wherein the input comprises an input matrix data structure having input matrix data structure positions corresponding to a set of exponent positions and a set of input mantissa positions associated with block floating point data;
wherein the plurality of multiplexers are wired to the set of input mantissa positions to transpose the input values corresponding to the set of input mantissa positions;
wherein the output comprises the output matrix index positions corresponding to the set of exponent positions and a set of output mantissa positions associated with block floating point data; and
wherein the set of exponent positions of the input are wired to the set of exponent positions of the output so as to propagate the set of exponent positions from input to output.

7. The device of claim 1, further comprising:
a matrix math circuit in communication with the output, the matrix math circuit comprising circuitry configured to perform at least one mathematical operation on the output matrix;
wherein the matrix math circuit comprises a matrix multiplier circuit configured to:
receive a second matrix, and
perform the at least one mathematical operation on the output matrix by multiplying the output matrix and the second matrix.

8. A system comprising:
at least one integrated circuit having a plurality of functional circuits; and
wherein the plurality of functional circuits comprises a matrix transposition functional circuit comprising:
an input to receive, for a plurality of input matrix index positions, matrix values of corresponding input matrix indices of an input matrix;
an output to supply, for a plurality of output matrix index positions, matrix values of corresponding output matrix indices of an output matrix; and
interconnection circuitry to connect each input matrix index position of the plurality of input matrix index positions of the input to an output matrix index position of the plurality of output matrix index positions of the output, each output matrix index position matching a transposed position of a corresponding input matrix index position so as to pass matrix values for the input matrix index positions to a corresponding output matrix index positions to yield the output matrix that is the transposition of the input matrix.

9. The system of claim 8, wherein the interconnection circuitry directly connects each input matrix index position, of the plurality of input matrix index positions, corresponding to diagonal input matrix indices of the input matrix to an output matrix index position, of the plurality of output matrix index positions, for a corresponding diagonal output matrix index of the output matrix.

10. The system of claim 8, wherein the matrix transposition function circuit is configured to pad the input matrix with additional rows of zero values to produce a square matrix when the input matrix comprises more columns than rows.

11. The system of claim 8, wherein the matrix transposition function circuit further comprises a plurality of multiplexers, wherein each multiplexer comprises:
first input wiring that wires each multiplexer to a first input matrix index position of the input matrix index positions of the input,
second input wiring that wires each multiplexer to a second input matrix index position of the input matrix index positions of the input, and
output wiring that wires each multiplexer to the output matrix index positions of the output;
wherein each multiplexer is configured to select between the first input matrix index position and the second input matrix index position;
wherein the first input matrix position and the output matrix index position are a same matrix index position of the input matrix such that selection of the first input matrix position produces the output matrix as the same as the input matrix; and
wherein the second input matrix position and the output matrix index position are different matrix index positions such that selection of the second input matrix position produces the output matrix as the transposition of the input matrix.

12. The system of claim 11, further comprising at least one control circuit configured to control the plurality of multiplexers to select between the first input matrix index position and the second input matrix index position.

13. The system of claim 11, wherein the input comprises an input matrix data structure having input matrix data structure positions corresponding to a set of exponent positions and a set of input mantissa positions associated with block floating point data;
wherein the plurality of multiplexers are wired to the set of input mantissa positions to transpose the input values corresponding to the set of input mantissa positions;
wherein the output comprises the output matrix index positions corresponding to the set of exponent positions and a set of output mantissa positions associated with block floating point data; and
wherein the set of exponent positions of the input are wired to the set of exponent positions of the output so as to propagate the set of exponent positions from input to output.

14. The system of claim 8, further comprising:
a matrix math circuit in communication with the output, the matrix math circuit comprising circuitry configured to perform at least one mathematical operation on the output matrix;
wherein the matrix math circuit comprises a matrix multiplier circuit configured to:
receive a second matrix, and
perform the at least one mathematical operation on the output matrix by multiplying the output matrix and the second matrix.

15. A method of manufacturing a semiconductor device comprising:
forming an input to receive, for a plurality of input matrix index positions, receive matrix values of corresponding input matrix indices of an input matrix;
forming an output to supply, for a plurality of output matrix index positions, matrix values of corresponding output matrix indices of an output matrix;
forming interconnection circuitry to connect each input matrix index position of the plurality of input matrix index positions of the input to an output matrix index position of the plurality of output matrix index positions, each output matrix index position matching a transposed position of a corresponding input matrix index position and the interconnection circuitry being arranged so as to pass matrix values for the input matrix index positions to a corresponding output matrix index positions to yield the output matrix that is a transposition of the input matrix.

16. The method of claim 15, wherein the interconnection circuitry directly connects each input matrix index position, of the plurality of input matrix index positions, corresponding to diagonal input matrix indices of the input matrix indices to an output matrix index position, of the plurality of output matrix index positions, for a corresponding diagonal input matrix index of the output matrix.

17. The method of claim 15, further comprising forming a plurality of multiplexers, wherein forming each multiplexer comprises:
forming first input wiring that wires each multiplexer to a first input matrix index position of the input matrix index positions of the input,
forming second input wiring that wires each multiplexer to a second input matrix index position of the input matrix index positions of the input, and
forming output wiring that wires each multiplexer to the output matrix index positions of the output;
wherein each multiplexer is configured to select between the first input matrix index position and the second input matrix index position;
wherein the first input matrix position and the output matrix index position are a same matrix index position of the input matrix such that selection of the first input matrix position produces the output matrix as the same as the input matrix; and
wherein the second input matrix position and the output matrix index position are different matrix index positions such that selection of the second input matrix position produces the output matrix as the transposition of the input matrix.

18. The method of claim 17, further comprising forming at least one control circuit configured to control the plurality of multiplexers to select between the first input matrix index position and the second input matrix index position.

19. The method of claim 17, further comprising:
forming the input to comprise an input matrix data structure having input matrix data structure positions corresponding to a set of exponent positions and a set of input mantissa positions associated with block floating point data;
wiring the plurality of multiplexers to the set of input mantissa positions to transpose the input values corresponding to the set of input mantissa positions;
wherein the output comprises the output matrix index positions corresponding to the set of exponent positions and a set of output mantissa positions associated with block floating point data; and
wiring the set of exponent positions of the input to the set of exponent positions of the output so as to propagate the set of exponent positions from input to output.

20. The method of claim 15, further comprising:
forming, in the semiconductor device, a matrix math circuit in communication with the output, the matrix math circuit comprising circuitry configured to perform at least one mathematical operation on the output matrix;
wherein the matrix math circuit comprises a matrix multiplier circuit configured to:
receive a second matrix, and
perform the at least one mathematical operation on the output matrix by multiplying the output matrix and the second matrix.
